(19) United States
(12) Patent Application Publication
(10) Pub. No.: US 2007/0047926 A1
(43) Pub. Date: Mar. 1, 2007

(54) Signal processing device for optical discs

(76) Inventors: Katsumi Morita, Kyoto (JP); Masaharu Imura, Osaka (JP); Yoichi Ogura, Osaka (JP); Tsutomu Kai, Osaka (JP); Shinichi Konishi, Nara (JP); Yorikazu Takao, Osaka (JP)

Correspondence Address: MCDERMOTT WILL & EMERY LLP, 600 13TH STREET, N.W., WASHINGTON, DC, 20005-3096, US

(21) Appl. No.: 11/512,266

(22) Filed: Aug. 30, 2006

(30) Foreign Application Priority Data
Aug. 31, 2005 (JP) 2005-251065

(51) Int. Cl. H04N 5/00

(52) U.S. Cl. 386/126

(57) ABSTRACT

The present invention provides a signal processing device for optical discs that is capable of more accurately check signal quality at a higher speed than the conventional technique, even if a playback RF signal is deteriorated.

A short recording mark detecting unit 115 detects short recording marks in an RF signal read from an optical disc 101, the short recording mark counting unit 116 counts a first short recording mark number as the number of the detected short recording marks, an error number counting unit 110 counts errors in the RF signal, an error number converting unit 111 converts the number of the errors to a second short recording mark number equivalent to the number of the errors, and a signal quality judging unit 112 judges recording quality based on a total of the first and second short recording mark numbers.

This application is based on an application No. 2005-251065 filed in Japan, the content of which is hereby incorporated by reference.

### BACKGROUND OF THE INVENTION

(1) Field of the Invention

The present invention relates to a technique for judging the quality of signals recorded on an optical disc.

(2) Description of the Related Art

In recent years, optical discs have been increased in capacity, and there is a demand for an optical disc apparatus that can record and play back large data at a high speed.

To meet the demand above, that is to say, to record and play back data at a high speed and improve reliability of the high-speed recording, it is necessary to verify the recorded signals at a high speed with accuracy for ensuring the signal quality.

With conventional optical disc apparatuses, an RF signal based on reflection light from an optical disc is binarized (by Level-Slice method) according to whether the level of the RF signal is higher or lower than a predetermined level, and an error correction is performed on the binarized signal. The signal quality is judged based on the number of errors.

However, if the data recording and the data playback is performed at a high speed, the frequency of the RF signal becomes high, and a photoelectric converting unit and a signal processing unit of an optical pickup can not manage the frequency of the playback RF signal, and this deteriorates the playback RF signal. In such a case, the conventional method for judging the signal quality might misjudge that the quality of the signal recorded on the optical disc is poorer than the actual quality. As a result, it becomes impossible to maintain the compatibility with low-speed recording.

During the playback, the waveform is modified to obtain a waveform pattern, based on which the original waveform is estimated. Therefore, if the signal is deteriorated, although the signal is playable, the signal quality might be overestimated. As a result, it becomes impossible to obtain an accurate signal quality.

In view of the above-described problem, the object of the present invention is to provide a signal processing device for optical discs that can verify signal quality with accuracy, at a speed higher than the conventional technique even if the playback RF signal is deteriorated.

[Patent Document 1] Japanese Laid-open Patent Application Publication No. H09-59515

[Patent Document 2] Japanese Laid-open Patent Application Publication No. H09-334342

[Patent Document 3] Japanese Laid-open Patent Application Publication No. H11-134421

### SUMMARY OF THE INVENTION

To solve the problem above, the present invention provides a signal processing device for recording and playing back data on an optical disc on which one or more recording tracks are concentrically or spirally formed, the signal processing device comprising: a short recording mark detecting unit operable to detect short recording marks from an RF signal generated based on light reflected from the optical disc, the short recording marks being shorter than a shortest recording mark defined in a standard; a short recording mark counting unit operable to count a first short recording mark number that is the number of the short recording marks detected by the short recording mark detecting unit; an RF signal binarizing unit operable to binarize the RF signal; an error correcting unit operable to correct errors in the binarized RF signal; an error counting unit operable to count the number of the errors; an error number converting unit operable to convert the number of the errors to a second short recording mark number that is the number of short recording marks indicating the same signal quality as the number of the errors indicates; and a signal quality judging unit operable to judge recording quality based on a total of the first short recording mark number and the second short recording mark number.

With the stated structure, the signal processing device according to the present invention is capable of more accurately judging the signal quality than the conventional technique, based on the number of the errors and the number of the short recording marks that is detectable even if the RF signal is deteriorated due to the high-speed spinning of the optical disc.

The signal processing device may further comprise a velocity capability switching unit operable to switch, in accordance with a linear velocity of the optical disc and an instruction from a drive control unit, a conversion coefficient or an offset value used by the error number converting unit and a judgment level used by the signal quality judging unit.

With the stated structure, the signal processing device according to the present invention is capable of more accurately judging the signal quality than the conventional technique, because the signal processing device is capable of obtaining the converted error number corresponding to the linear velocity of the optical disc.

The signal processing device may further comprise a short recording mark number adjusting unit operable to adjust the first short recording mark number by multiplying by an adjustment coefficient or adding an offset value, to obtain a first adjusted error number, wherein the error number converting unit converts the number of the errors counted by the error number counting unit to a second adjusted error number, and the signal quality judging unit judges the recording quality based on a total of the first adjusted error number and the second adjusted error number.

With the stated structure, since the signal processing device converts the number of the short recording marks and the number of the errors to the adjusted error number, the signal processing device is capable of judging the signal quality based on a single criterion.

For example, in the case of the low speed, the number of the errors and the number of the short recording marks counted in the case of the high speed are converted to an equivalent error number for the case of the low speed, and the signal quality is judged based on the equivalent number. This means that the signal processing device is capable of judging the signal quality of the case of the high speed without preparing an additional module or a criterion for judging the signal quality of the high speed case.

The signal processing device may further comprise a velocity capability switching unit operable to switch, in accordance with a linear velocity of the optical disc and an instruction from a drive control unit, a conversion coefficient or an offset value for the error number converting unit, a adjustment coefficient or an offset value for the short recording mark number adjusting unit, and a judgment level for the signal quality judging unit.

With the stated structure, the signal processing device is capable of obtaining a result of the signal quality judgment with consideration of the linear velocity of the disc.

The signal processing device may further comprise a short recording mark level judging unit operable to judge a level of the first short recording mark number, wherein the short recording mark number adjusting unit adjusts the first short recording mark number by changing the adjustment coefficient or the offset value in accordance with the level judged by the short recording mark level judging unit.

With the stated structure, the short recording marks are classified based on the level. Therefore, the number of the conversion coefficients and the offset values that the signal processing device is required to hold is limited to the number of the levels. This means that the amount of data that the signal processing device is required to hold is reduced.

The signal processing device may further comprise a velocity capability switching unit operable to switch, in accordance with a linear velocity of the optical disc, a conversion coefficient or an offset value used by the error number converting unit, the level judged by the short recording mark level judging unit, the adjustment coefficient or the offset value used the short recording mark number adjusting unit, and the judgment level used by the signal quality judging unit.

With the stated structure, the signal processing device is capable of obtaining a result of the signal quality judgment with consideration of the linear velocity of the disc.

The signal processing device may further comprise, instead of the short recording mark number adjusting unit, a short recording mark replacing unit operable to replace the first short recording mark number with a fixed value in accordance with the level judged by the short recording mark level judging unit.

With the stated structure, the number of the short recording marks is counted for each level, and converted to a fixed value for each level. Therefore, the data structure and the circuit structure can be simplified.

The signal processing device may further comprise a velocity capability switching unit operable to switch, in accordance with a linear velocity of the optical disc and an instruction from a drive control unit, a conversion coefficient or an offset value used by the error number converting unit, the judgment level used by the short recording mark level judging unit, the fixed value used by the short recording mark number adjusting unit, and the judgment level used by the signal quality judging unit.

With the stated structure, the signal processing device is capable of obtaining a result of the signal quality judgment with consideration of the linear velocity of the disc.

The signal processing device may further comprise: a memory unit operable to store the first short recording mark number in each of adjoining sectors; and an adjoining sectors comparing unit operable to compare the first short recording mark number of a certain sector among the adjoining sectors and the first short recording mark number of sectors adjoining the certain sector, and judge whether each first short recording mark number is more than a predetermined value, wherein the short recording mark number adjusting unit adjusts the first short recording mark number of each of the adjoining sectors to obtain an adjusted short recording mark number in accordance with a result of the judgment by the adjoining sectors comparing unit.

With the stated structure, the signal processing device is capable of judging the signal quality based on the number of the short recording marks detected in the adjoining sectors.

For example, in the case of judging the signal quality in a plurality of sectors by adding the number of the short recording marks in the plurality of the sectors, even if the number of the short recording marks in a certain sector is extremely larger than the sectors adjoining to the certain sector, the signal processing device is capable of preventing the large number as to the certain sector affecting the signal quality of the block, by adjusting the large number to a predetermined upper limit.

The signal processing device may further comprise a velocity capability switching unit operable to switch units to be used for judging the recording quality in accordance with a linear velocity of the optical disc such that an RF signal level-slice unit, the error correcting unit and the error counting unit are used if the linear velocity is low, and the short recording mark detecting unit, the short recording mark counting unit, the RF signal binarizing unit, the error correcting unit, the error counting unit, the error number converting unit and the signal quality judging unit are used if the linear velocity is high.

With the stated structure, the signal processing device is capable of switching the units to be used for the signal quality judgment in accordance with the linear velocity of the disc to appropriately judge the signal quality.

The signal processing device may further comprise: an RF signal envelope detecting unit operable to detect existence of the RF signal; and a signal masking unit operable, if the RF signal is missing, to mask a signal input to the short recording mark detecting unit so as not to detect the short recording marks

With the stated structure, the signal processing device is capable of preventing that more than the actual number of the short recording marks is detected in the case where the amplitude of the RF signal envelope is small, in other words, in the case where the signal is not properly recorded on the disc.

The signal processing apparatus may further comprise: a waveform equalizing filter unit and a Viterbi decoding unit operable to perform PRML (Partial Response Maximum Likelihood) processing; a filter coefficient memory unit that prestores a filter coefficient for testing the recording quality; and a filter coefficient switching unit operable to set the filter coefficient to the waveform equalizing filter unit when testing or verifying the quality of the RF signal.

With the stated structure, the signal processing device is capable of judging the signal quality based on the RF signal that is output stably.

The present invention also provides a signal processing device for recording and playing back data on an optical disc on which one or more recording tracks are concentrically or spirally formed, the signal processing device comprising: an RF signal binarizing unit operable to binarize an RF signal generated based on light reflected from the optical disc; an error correcting unit operable to correct errors in the binarized RF signal; an error counting unit operable to count the number of errors that the error correcting unit has failed to correct; an error number converting unit operable to convert the number of the errors to a second short recording mark number that is the number of short recording marks indicating the same signal quality as the number of the errors indicates; a waveform equalizing filter unit and Viterbi decoding unit operable to perform PLML processing on an output from a playback signal processing unit; a signal quality judging unit operable to judge recording quality based on an output from the error number counting unit or an output from the Viterbi decoding unit; and a velocity capability switching unit operable, in accordance with a linear velocity of the optical disc, to switch an input to the signal quality judging unit to an output from the error number counting unit if the linear velocity is low, and to an output from the Viterbi decoding unit if the linear velocity is high.

The velocity capability switching unit may switch a judgment level used by the signal quality judging unit in accordance with the linear velocity of the optical disc.

With the stated structure, the signal processing device is capable of determining whether to use the PRML (Partial Response Maximum Likelihood) based on the linear velocity of the optical disc.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 is a block diagram showing a structure of an optical disc apparatus according to the first embodiment of the present invention;

FIG. 2 schematically shows RF signals and short recording marks;

FIG. 3 is a flowchart showing processing for judging signal quality;

FIG. 4 is a block diagram showing a structure of an optical disc apparatus according to the second embodiment of the present invention;

FIG. 5 is an example of a zone conversion coefficient table stored in an error number converting unit;

FIG. 6 is an example of a zone threshold value table stored in a signal quality judging unit;

FIG. 7 is a block diagram showing a structure of an optical disc apparatus according to the third embodiment of the present invention;

FIG. 8 is an example of an error number conversion parameter table stored in an error number converting unit;

FIG. 9 is an example of a level judgment table stored in a short recording mark level judging unit;

FIG. 10 is an example of a short recording mark number adjustment parameter table stored in a short recording mark number adjusting unit;

FIG. 11 is a block diagram showing a structure of an optical disc apparatus according to the fourth embodiment of the present invention;

FIG. 12 is an example of a data structure of the number of short recording marks detected in each sector, stored in a memory unit;

FIG. 13 is an example of a correspondence table showing short recording mark levels and short recording mark numbers as fixed values;

FIG. 14 is a block diagram showing a structure of an optical disc apparatus according to a modification of the present invention;

FIG. 15 is a block diagram showing a structure of an optical disc apparatus according to a modification of the present invention;

FIG. 16 is a block diagram showing a structure of an optical disc apparatus according to a modification of the present invention;

FIG. 17 is a block diagram showing a structure of an optical disc apparatus according to a modification of the present invention; and

FIG. 18 is a flowchart showing processing for judging signal quality according to the third embodiment of the present invention.

### DESCRIPTION OF THE PREFERRED EMBODIMENT

The following describes embodiments of the present invention with reference to drawings.

### First Embodiment

An optical disc apparatus 1 according to the first embodiment of the present invention improves the accuracy in judging the signal quality by counting the number of errors found in the error correction process and the number of short recording marks that are playback signals deteriorated due to the high speed spinning of the optical disc and so on, and judging the signal quality using the number of errors and the number of the short recording marks, instead of judging the signal quality using only the number of the errors as in the conventional technique.

<Structure>

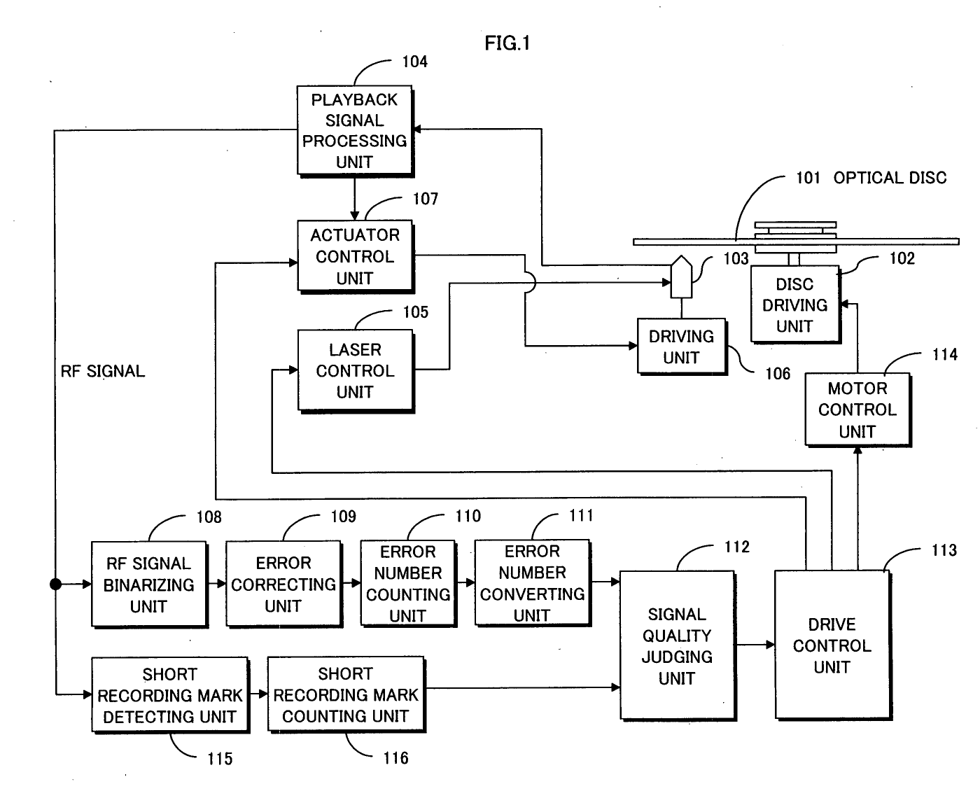

As FIG. 1 shows, an optical disc apparatus according to the first embodiment of the present invention includes a disc driving unit 102, a pickup 103, a playback signal processing unit 104, a laser control unit 105, a driving unit 106, an actuator control unit 107, an RF signal binarizing unit 108, an error correcting unit 109, an error number counting unit 110, an error number converting unit 111, a signal quality judging unit 112, a drive control unit 113, a motor control unit 114, a short recording mark detecting unit 115 and a short recording mark counting unit 116, and an optical disc 101 is set to the optical disc apparatus.

The optical disc apparatus is, more specifically, a computer system including a microprocessor, a ROM, a RAM, an optical disc drive unit, and soon. A computer program is stored in the RAM. The optical disc apparatus achieves functions as a result of the microprocessor operating in accordance with the computer program.

The optical disc 101 is a disc such as a CD-ROM, a CD-R, a CD-RW, a DVD-RAM, a DVD+RW and a PD, on which reading and writing of information is performed using a laser beam.

In this embodiment, the optical disc 101 is assumed as a DVD-RAM, and an address signal of a sector is assumed to be recorded in each sector. Also, it is assumed that each sector is constituted of thirteen Rows, and each row is constituted of 182 bytes.

The disc driving unit 102 is realized with a spindle motor, and operates in accordance with ZCLV (Zone Constant Liner Velocity) method. With the ZCLV method, an optical disc is divided into several zones arranged from the inner circumference of the disc, and a linear velocity of each zone is maintained at a constant value. A DVD-RAM includes 35 zones. The innermost zone includes 35104 sectors, and the outermost zone includes 105728 sectors.

The pickup 103 receives instructions such as a laser strength and an output timing from the laser control unit 105, emits a laser beam onto an information recording surface of the optical disc 101, reads a light reflected from the optical disc 101 using a photo detector included in the pickup 103 to convert the reflection light to an RF signal, and outputs the RF signal to the playback signal processing unit 104.

The pickup 103 also receives, using the photo detector, a light reflected and diffracted by a guide groove of the optical disc 101, to convert the reflected and diffracted light to a control signal, and outputs the control signal to the playback signal processing unit 104.

The control signal includes signals for controlling a position of the pickup 103, such as a tracking control signal.

The playback signal control unit 104 outputs the RF signal received from the pickup 103 to the RF signal binarizing unit 108, and also outputs the received control signal to the actuator control unit 107.

The actuator control unit 107 receives the control signal from the playback signal processing unit 104. The actuator control unit 107 also receives, from the drive control unit 113, velocity information indicating a linear velocity of the optical disc and operation information including an identifier of data to be read or written. The actuator control unit 107 instructs the driving unit 106 to control the tracking and the position of the pickup 103 so that the pickup 103 is able to read and write the data at the linear velocity indicated by the velocity information.

The driving unit 106 is constituted of a spindle motor. The driving unit 106 receives instructions from the actuator control unit 107. In accordance with the instructions, the driving unit 106 controls the tracking, and moves the pickup 103 in the radial direction of the optical disc 101.

The laser control unit 105 receives, from the drive control unit 113, velocity information indicating a linear velocity of the optical disc 101, and informs the pickup 103 of the strength of the laser beam and an output timing and so on in accordance with the linear velocity.

The motor control unit 114 receives, from the drive control unit 113, the velocity information indicating the linear velocity of the optical disc 101, and instructs the disc driving unit 102 to spin the optical disc 101 at the linear velocity.

The disc driving unit 102 is constituted of a motor, and spins the optical disc 101 in accordance with the instruction received from the motor control unit 114.

The drive control unit 113 controls the whole operations for reading data from the optical disc 101 and writing data onto the optical disc 101.

The drive control unit 113 holds drive control information, such as the velocity information indicating the linear velocity of the optical disc 101 and the operation information including the identifier of the data to be read or written.

The drive control unit 113 also receives quality information indicating whether the signal quality is good or bad from the signal quality judging unit 112.

If the quality information indicates that the signal quality is “bad”, the drive control unit 113 controls the laser control unit 105, the actuator control unit 107 and the motor control unit 114 so as to use a spare region prepared on the optical disc 101 afterwards, instead of using the block whose signal quality is bad.

The RF signal binarizing unit 108 generates an OFT signal from the RF signal received from the playback signal processing unit 104, and outputs the OFT signal to the error correcting unit 109.

Here, recording marks are recorded on the optical disc 101 by Mark Edge recording method. The OFT signal is a signal generated by binarizing the RF signal to an H signal and an L signal, assuming the edge parts of the RF signal as data. The OFT signal includes an address signal and a data signal for each sector.

The error correcting unit 109 performs error correction on the binarized signal output from the RF signal binarizing unit 108, using the Reed-Solomon Product Code. This error correction is performed in units of ECC blocks each including 16 sectors.

The Reed-Solomon Product Code is a well-known technique, and therefore it is not explained here.

The error correcting unit 109 outputs a pulse signal to the error number counting unit 110 every time the error is detected in the above-described error correction.

The error number counting unit 110 counts up the number of detected error bytes every time the error number counting unit 110 receives the pulse. The number of the detected error bytes is count up for each ECC.

The short recording mark detecting unit 115 detects a short recording mark included in the RF signal received from the playback signal processing unit 104.

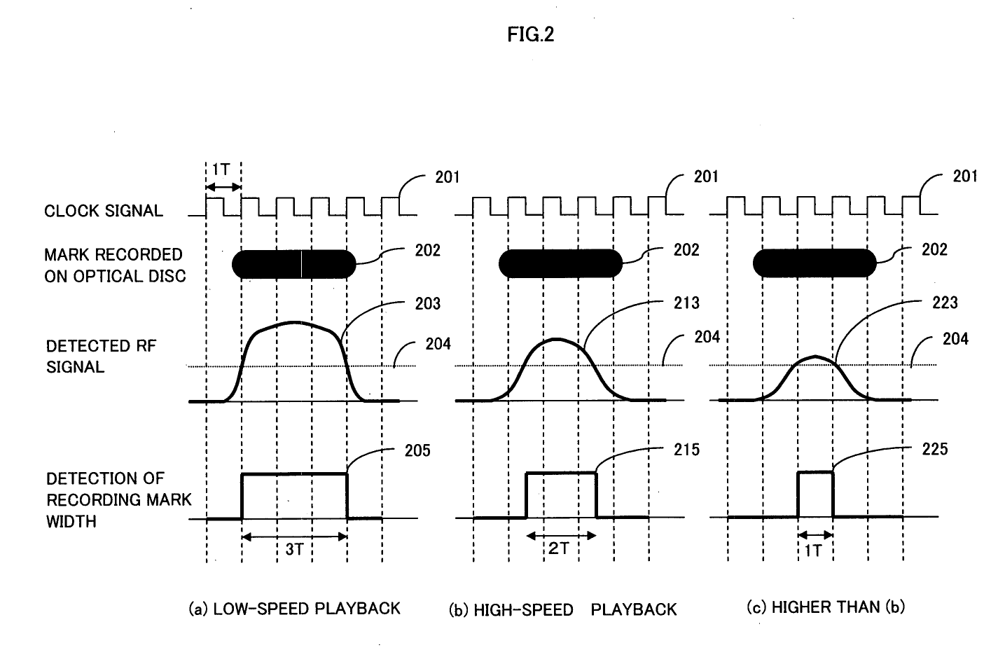

The following describes the RF signal and the short recording mark, with reference to FIG. 2.

A recording mark, shown in FIG. 2A as a recording mark 202 for instance, is recorded on the optical disc 101.

The time length of the recording mark 202 is 3T, where a reference value is a cycle length (1T) of a read clock signal in the case where the optical disc 101 is spinning at a low speed, such as a 2× (double) speed.

The time length of each recording mark recorded on the optical disc 101 is 3T to 14T, and any recording mark whose time length is 1T or 2T is not recorded on the optical disc 101.

A signal waveform 203 represents the waveform of the RF signal generated from the read reflection light in the case where the optical disc 101 is spinning at a low speed (e.g. 2× speed, see FIG. 2A). Regarding the signal waveform 203, a portion whose amplitude is equal to or higher than a predetermined threshold value 204 corresponds to a high level of an output signal 205, and a portion whose amplitude is lower than the predetermined threshold value 204 corresponds to a low level of the output signal 205. In this example, the time length of the high level of the output signal 205 (hereinafter called “the recording mark width”) is 3T.

In the case where the optical disc 101 is being played back at a high speed (e.g. 8× speed playback, see FIG. 2B), the RF signal generated from the reflection light read by the pickup 103 irradiating the recording mark 202 with a laser beam might be deteriorated compared to that of the low speed playback, and as a result, the waveform is sometimes in the form illustrated as a signal waveform 213 in FIG. 2.

If this is the case, the recording mark width of the output signal 215 corresponding to the waveform 213 becomes 2T, which normally should be 3T. In the same manner, in the case where the optical disc 101 is being played back at an even higher speed (e.g. 16× speed, see FIG. 2C), the waveform of the RF signal generated from the reflection light read by the pickup 103 irradiating the recording mark 202 with a laser beam is sometimes in the form illustrated as a signal waveform 223. In this case, the recording mark width of the output signal 225 corresponding to the waveform 223 becomes 1T, which normally should be 3T.

In the explanation above, a recording mark whose recording mark width is judged as 2T and a recording mark whose recording mark width is judged as 1T are called “short recording marks”.

The short recording mark counting unit 116 counts, for each ECC block, the number of detected short recording marks detected by the short recording mark detecting unit 115.

The error number converting unit 111 receives the number of the detected error bytes from the error number counting unit 110, and converts the number of the detected error bytes to a converted short recording mark number, which represents the number of the detected short recording marks. Then, the error number converting unit 115 outputs the converted short recording mark number to the signal quality judging unit 112.

The conversion from the number of the detected error bytes to the converted short recording mark number is performed based on the following equation, for example:
“Converted Short Recording Mark Number=0.8×Number of Detected Errors”

This equation should be previously derived from experiments and so on.

For instance, the equation representing the relation between the number of the errors and the number of the short recording marks can be obtained by reading an optical disc that is spinning at a high speed and does not include writing errors, counting the number of the errors occurred during the reading, and also counting the number of the short recording marks. Alternatively, it is possible to obtain the equation by simulation and so on, without performing experiments.

The signal quality judging unit 112 receives the converted short recording mark number from the error number converting unit 111, and receives the number of the detected short recording marks from the short recording mark number counting unit 116. Then, the signal quality judging unit 112 sums up the obtained converted short recording mark number and the obtained number of the detected short recording marks to obtain a total short recording mark number. The signal quality judging unit 112 judges the signal quality using the total short recording mark number.

The signal quality judging unit 112 judges that the signal quality is “bad” if the total short recording mark number is equal to or greater than a predetermined threshold value (e.g. 60), and judges that the signal quality is “good” if the total short recording mark number is smaller than the threshold value. The signal quality judging unit 112 outputs a quality notification, which indicates “good” or “bad”, to the drive control unit 113.

<Operations>

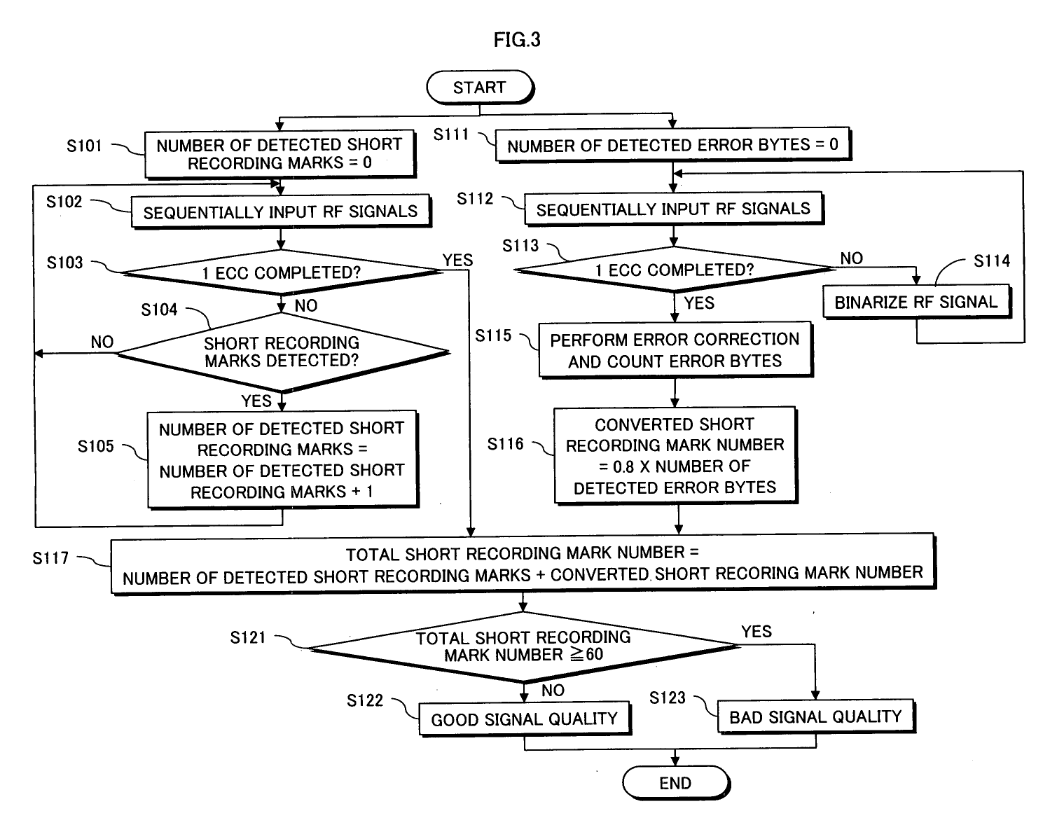

The following describes, with reference to FIG. 3, operations for judging signal quality relating to one ECC block, which are main operations of this embodiment of the present invention.

Each of the RF signal binarizing unit 108 and the short recording mark detecting unit 115 receives RF signals corresponding to one ECC block from the playback signal processing unit 104.

The short recording mark counting unit 110 sets a default value “0” to the number of the detected short recording mark, which is an internal variable (Step S101).

The short recording mark detecting unit 115 sequentially receives RF signals from the playback signal processing unit 104 (Step S102).

The short recording mark detecting unit 115 keeps on receiving RF signals until the signal length of the RF signals reaches a length corresponding to one ECC block.

The short recording mark detecting unit 115 judges whether the reception of the RF signals corresponding to one ECC block has been completed (Step S103). If the reception has not been completed (Step S103: NO), the short recording mark detecting unit 115 detects the short recording marks. If no short recording mark has been detected (Step S104: NO), the processing returns to Step S102. If a short recording mark has been detected (Step S104: YES), the short recording mark detecting unit 115 increments the number of the detected short recording marks by 1 (Step S105), and the processing returns to Step S102.

In Step S103, if the short recording mark detecting unit 115 judges that the reception of the RF signals corresponding to one ECC block has been completed (Step S103: YES), the short recording mark counting unit 116 transmits the number of the detected short recording marks to the signal quality judging unit 112, and the processing jumps to Step S117, which is described later.

In parallel with Steps S101 to S105, firstly, the error number counting unit 110 sets a default value “0” to the number of the detected error bytes, which is an internal variable (Step S111).

Then, in parallel with Step S102, the RF signal binarizing unit 108 sequentially receives RF signals from the playback signal processing unit 104 (Step S112).

The RF signal binarizing unit 108 judges whether the reception of the RF signals corresponding to one ECC block has been completed (Step S113). If the reception has not been completed (Step S113: NO), the RF signal binarizing unit 108 binarizes the received RF signals (Step S114), and the processing moves to Step S112.

In Step S113, if the RF signal binarizing unit 108 judges that the reception of the RF signals corresponding to one ECC block has been completed (Step S113: YES), the error correcting unit 109 performs, using the above-described Reed-Solomon Product Code, error correction within the received one ECC block. If an error is detected during the error correction performed by the error correcting unit 109, the error number counting unit 110 increments the number of the detected error byte (Step S115).

After finishing the error correction, the error number counting unit 110 transmits the number of the detected error bytes to the error number converting unit 111.

The error number converting unit 111 receives the number of the detected error bytes, and calculates the converted short recording mark number according to the equation “Converted Short Recording Mark Number=0.8×Number of Detected Error Bytes” (Step S116). Then, the error number converting unit 111 transmits the converted short recording mark number as a result of the calculation to the signal quality judging unit 112.

In the case where the signal quality judging unit 112 receives the number of the detected short recording marks from the short recording mark counting unit 116 and receives the converted short recording mark number from the error number converting unit 111, the signal quality judging unit 112 sums up the number of the detected short recording marks and the converted short recording mark number to obtain the sum as the total short recording mark number (Step S117).

The signal quality judging unit 112 judges that the signal quality is “bad” if the total short recording mark number is equal to or greater than 60 (Step S121: YES), and judges that the signal quality is “good” if the total short recording mark number is smaller than 60 (Step S121: NO). The signal quality judging unit 112 outputs a quality notification, which indicates “good” or “bad”, to the drive control unit 113.

<Summary>

In the case where the optical disc is spinning at a high speed such as at a 16× speed, the RF signals might be deteriorated due to the frequency characteristic of the photoelectric converting unit and the playback signal processing unit 104, which are included in the pickup 103.

If the signal quality of the deteriorated RF signals is judged in the conventional manner, it might be judged as bad even though actual recording quality is good. Also, it becomes impossible to maintain the compatibility with low-speed recording.

The present invention detects the short recording marks whose recording mark width is 2T, 1T or the like, in addition to the above-described number of the errors, and uses the number of the short recording marks for judging the signal quality.

If the optical disc is spinning at a low speed, the short recording mark is often recognized as a normal recording mark whose recording mark width is not smaller than 3T.

The present invention converts the number of the errors detected in the error correction process to the number of the short recording marks, and judges the signal quality based on the total of the number of the short recording marks converted from the number of the errors and the number of the detected short recording marks.

Accordingly, even if the optical disc is spinning at a high speed and the RF signals are deteriorated, the present invention is capable of judging the signal quality more accurately than the conventional technique.

### Second Embodiment

The following describes a second embodiment of the present invention, mainly as to differences from the first embodiment.

As described above, the optical disc is divided into several zones beginning with the inner circumference of the disc. The second embodiment is different from the first embodiment in that the conversion coefficient and the judging level are different for each zone. In the first embodiment, the error number converting unit 111 converts the number of the detected error byes to the converted short recording mark number using the equation “Converted Short Recording Mark Number=0.8×Number of Detected Error Bytes”. However, in the second embodiment, an equation is prepared for each zone, and the conversion from number of the detected error bytes to the converted short recording mark number is performed using the equation corresponding to the zone. The equation for each zone should be previously derived from experiments and so on, in the same manner as in the first embodiment.

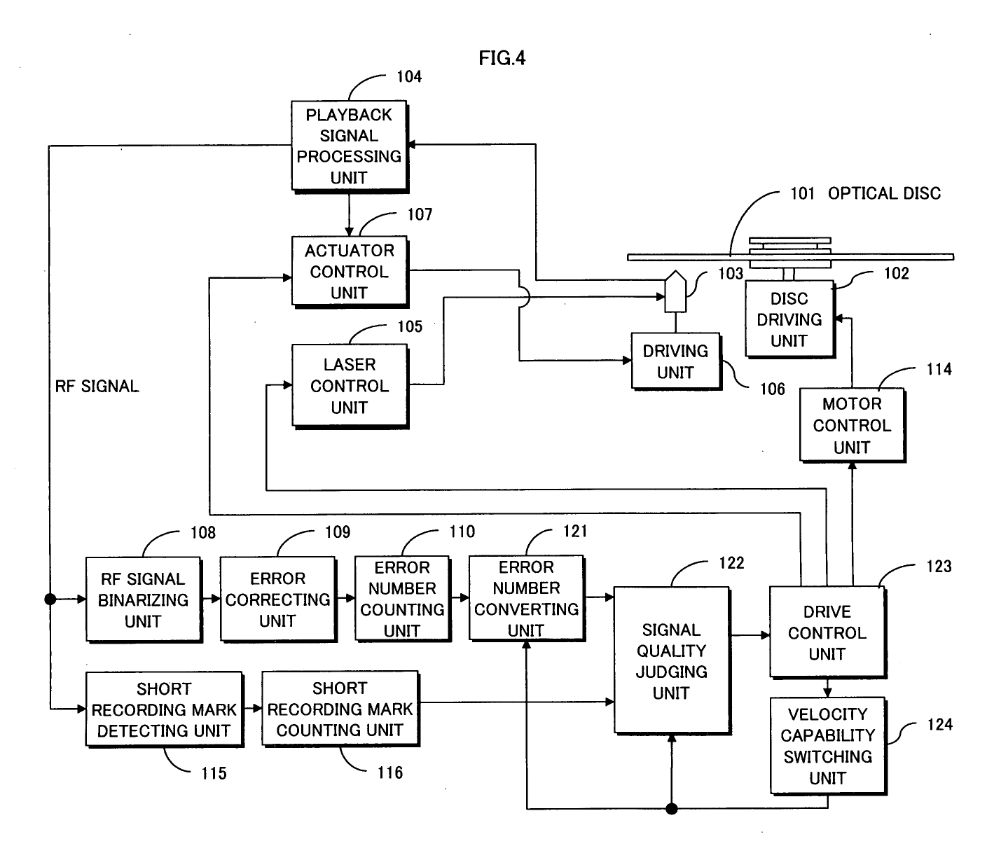

An optical disc apparatus according to the second embodiment of the present invention includes, as shown in FIG. 4, a disc driving unit 102, a pickup 103, a playback signal processing unit 104, a laser control unit 105, a driving unit 106, an actuator control unit 107, an RF signal binarizing unit 108, an error correcting unit 109, an error number counting unit 110, an error number converting unit 121, a signal quality judging unit 122, a drive control unit 123, a motor control unit 114, a short recording mark detecting unit 115, a short recording mark counting unit 116 and a velocity capability switching unit 124, and an optical disc 101 is to be set to the optical disc apparatus. In FIG. 1 and FIG. 4, the same unit is referred to with the same number.

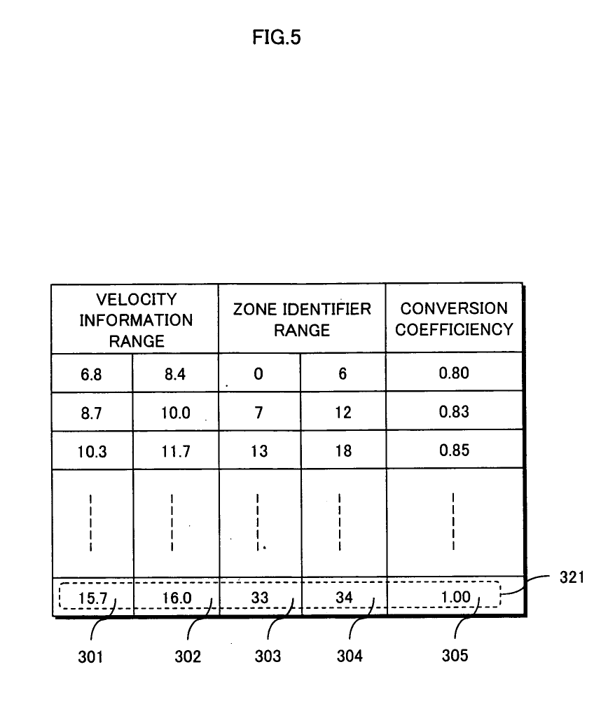

The error number converting unit 121 is almost the same as the error number converting unit 111. However, the error number converting unit 121 holds, as FIG. 5 shows as an example, a zone conversion coefficient table constituted of zone conversion coefficient entries, each representing the correspondence among a velocity information range representing a range of a linear velocity of a played back disc, a zone identifier range, and a conversion coefficient used in a conversion equation relating to the zone.

The equation for the conversion used in this embodiment is:
“Converted Short Recording Mark Number=Conversion Coefficient×Number of Detected Error Bytes”.

The value included in the zone conversion coefficient entry is used as the conversion coefficient in the equation.

The velocity information range includes start velocity information indicating a start point of the range and end velocity information indicating an end point of the range.

The zone identifier range includes a start identifier indicating a start point of the range and an end identifier indicating an end point of the range.

For example, a zone conversion coefficient entry 321 includes start velocity information 301 having a value “15.7” and end velocity information 302 having a value “16.0”, which represent that the linear velocity of the disc is in a range of a 15.7× speed to a 16.0× speed inclusive. The zone conversion coefficient entry 321 also includes a start identifier 303 and an end identifier 304 which represent that the value of the zone identifier is within a range of “33” to “34” inclusive, and a conversion coefficient 305 having a value “1.00”.

The error number converting unit 121 receives the velocity information and the zone identifier from the velocity capability switching unit 124, and selects, from the zone conversion coefficient table, a zone conversion coefficient entry corresponding to the received velocity information and zone identifier, and extracts the conversion coefficient.

For example, in the case of receiving velocity information “16” and a zone identifier “33” from the velocity capability switching unit 124, the error number converting unit 121 refers to the zone conversion coefficient table, selects the zone conversion coefficient entry 321 corresponding to the velocity information “16” and the zone identifier “33”, and extracts the conversion coefficient “1.00” from the zone conversion coefficient entry 321.

In this case, the error number converting unit 121 uses an equation “Converted Short Recording Mark Number=1.00×Number of Detected Error Bytes” for the conversion.

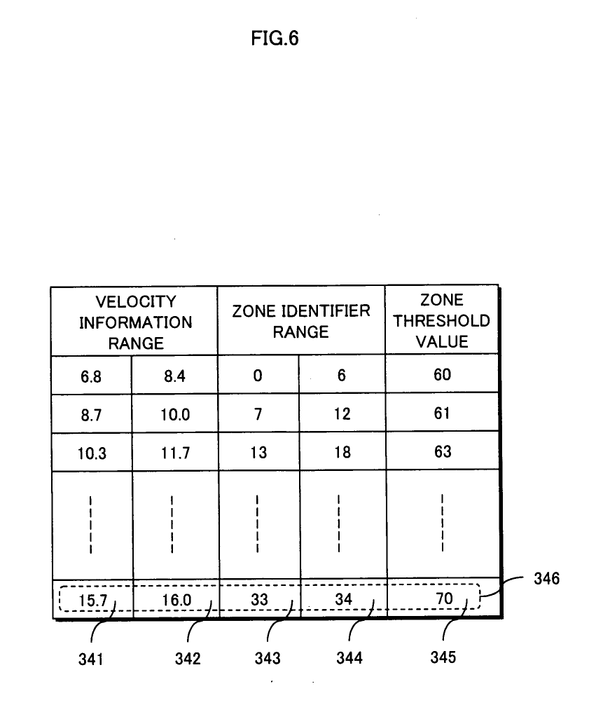

The signal quality judging unit 122 is almost the same as the signal quality judging unit 112. However, as shown in FIG. 6 as an example, the signal quality judging unit 122 holds a zone threshold value table constituted of zone threshold value entries, each including a velocity information range representing a range of a linear velocity of a played back disc, a zone identifier range, and a zone threshold value that is a threshold value of the zone within the zone identifier range.

A zone threshold value entry 346 includes start velocity information 341 whose value is “15.7” and end velocity information 342 whose value is “16”, which indicate that the linear velocity of the disc is within a range from a 15.7× speed to a 16× speed, a start identifier 343 and an end identifier 344 which indicate that the value of the zone identifier is within a range from “33” to “34”, and a zone threshold value 345 whose value is “70”.

The signal quality judging unit 122 receives the velocity information and the zone identifier from the velocity capability switching unit 124, and selects a zone threshold value entry corresponding to the received velocity information and zone identifier to determine the zone threshold value.

For example, in the case where the signal quality judging unit 122 receives velocity information “16” and a zone identifier “33” from the velocity capability switching unit 124, the signal quality judging unit 122 refers to the zone threshold value table, selects a zone threshold value 341 corresponding to the velocity information “16” and the zone identifier “33”, and extracts a zone threshold value 345 whose value is “70” from a zone threshold value entry 346.

In Step S121 of the first embodiment, the signal quality judging unit 112 judges that the signal quality is “bad” if the total short recording mark number is equal to or greater than 60. However, the signal quality unit 122 judges that the signal quality is “bad” if the total short recording mark number is equal to or greater than the selected zone threshold value (“70” in the example above).

The zone threshold value table should be previously determined based on experiments and so on. Alternatively, it is possible to determine the table by simulation and so on, without performing experiments.

### Third Embodiment

In the second embodiment, the number of error bytes detected in the error correction and the number of the short recording marks are counted, and the number of error bytes is converted to the converted short recording mark number equivalent to the number of the detected short recording marks. The signal quality is judged using the total short recording mark number, which is the total of the number of the detected short recording marks and the converted short recording mark number.

The third embodiment is characterized by that each of the number of the detected error bytes and the number of the detected short recording marks in the case where the optical disc is spinning at a high speed is converted to a low-speed error number which corresponds to the number of the detected error bytes in the case where the disc is spinning at a low speed, which is a conventional speed, and the signal quality is judged using the low-speed error number.

With this feature, it is possible to take the number of the detected short recording marks into consideration at the judgment of the signal quality. Also, it is possible to use a conventional algorithm and so on for judging the signal quality using the number of error bytes detected at the low speed. Therefore, the structure does not become complicated and the compatibility with low-speed recording can be maintained.

The following describes the third embodiment as to only differences from the second embodiment.

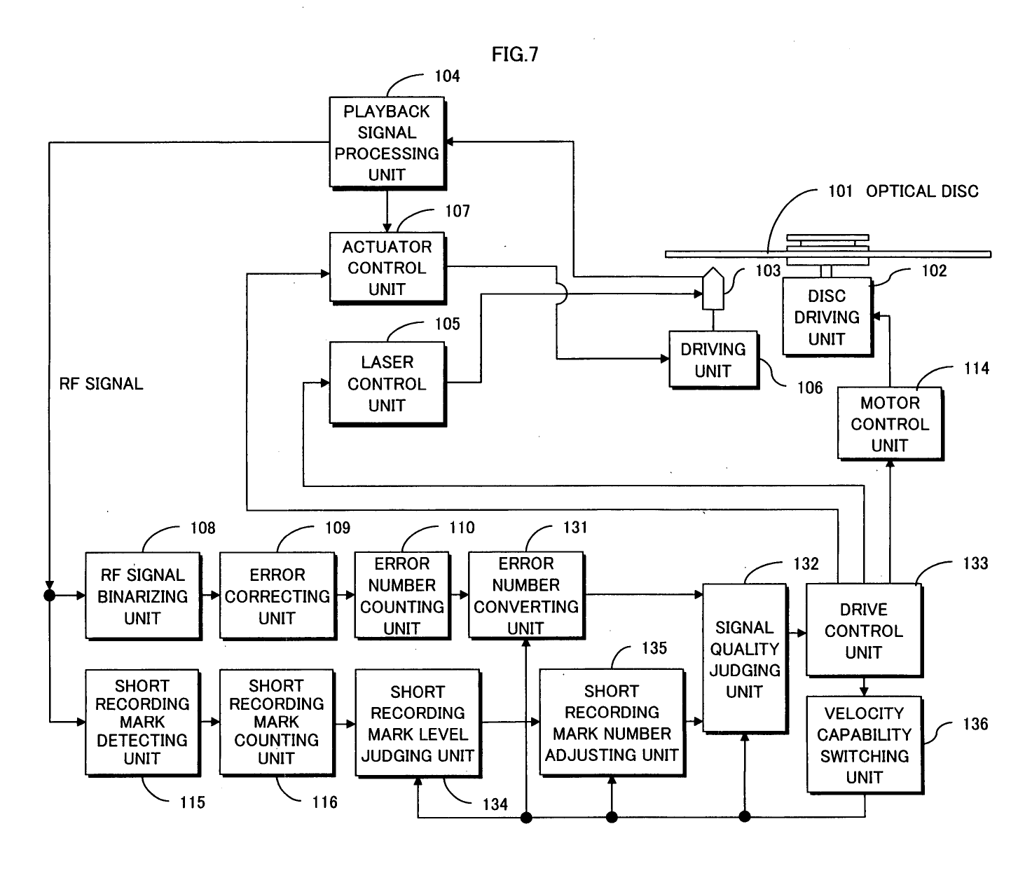

As FIG. 7 shows, the optical disc apparatus according to the third embodiment of the present invention includes a disc driving unit 102, a pickup 103, a playback signal processing unit 104, a laser control unit 105, a driving unit 106, an actuator control unit 107, an RF signal binarizing unit 108, an error correcting unit 109, an error number counting unit 110, an error number converting unit 131, a signal quality judging unit 132, a drive control unit 133, a motor control unit 114, a short recording mark detecting unit 115, and a short recording mark counting unit 116, a short recording mark level judging unit 134, a short recording mark number adjusting unit 135 and a velocity capability switching unit 136. In FIG. 7 and FIG. 4, the same unit is referred to with the same number.

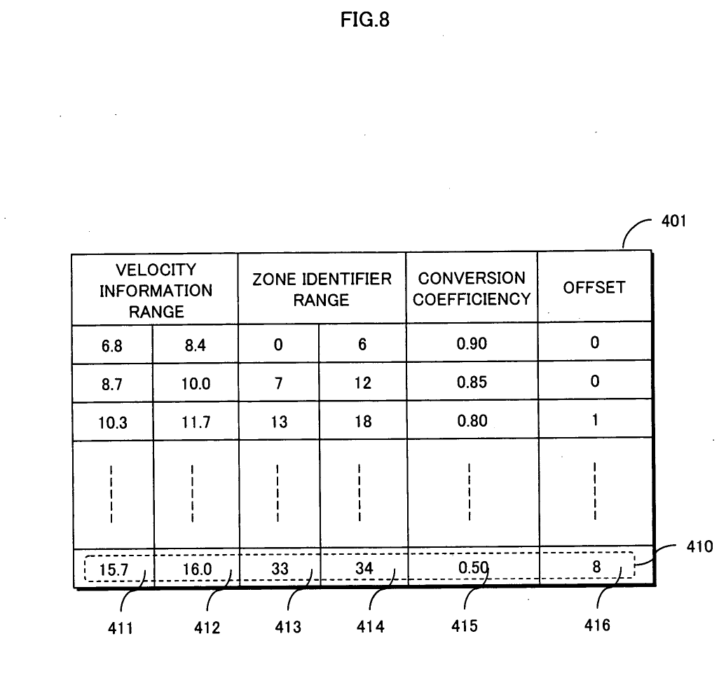

The error number converting unit 131 holds an error number conversion parameter table 401, which is shown in FIG. 8 as an example.

The error number conversion parameter table 401 is constituted of a plurality of error number conversion parameter entries, each including a velocity information range, a zone identifier range, a conversion coefficient and an offset.

The velocity information range represents a range of a linear velocity of an optical disc. The zone identifier range represents a range of the zone. The conversion coefficient and the offset are parameters for a conversion equation for converting the number of the detected error bytes to the number of errors at a low speed.

In the third embodiment, the equation is assumed as “Error Number at Low Speed=Coefficient×Number of Detected Error Bytes+Offset”.

For example, an error number conversion parameter entry 410 includes start velocity information 411 whose value is “15.7” and end velocity information 412 whose value is “16.0”, which represent that the linear velocity of the disc is between a 15.7× speed and a 16× speed. The error number conversion parameter entry 410 also includes a zone identifier range, a conversion coefficient 415 whose value is “0.5”, and an offset 416 whose value is “8”.

The zone identifier range includes a start identifier indicating a start point of the range and an end identifier indicating an end point of the range. A start identifier 413 has a value “33”, and an end identifier 414 has a value “34”. This means that the zone identifier range including the start identifier 413 and the end identifier 414 represents a range “33-34”.

Here, in the case of receiving parameters namely the velocity information “16”, the zone identifier “33” and the number of the detected error bytes “50” from the error number counting unit 110, the error number converting unit 131 selects a error number conversion parameter entry 410 which corresponds to the received parameters, and performs, using the conversion coefficient 415 and the offset 416 included in the error number conversion parameter entry 410, a calculation “0.5×50+8=33” thereby obtains a low-speed error number “33” as a calculation result.

The error number conversion parameter table should be previously determined based on experiments and so on.

Alternatively, it is possible to determine the table by simulation and so on, without performing experiments.

The short recording mark level judging unit 134 receives the velocity information, the zone identifier and the number of the detected short recording marks counted by the short recording mark counting unit 116, judges the short recording mark level, and outputs the short recording mark level.

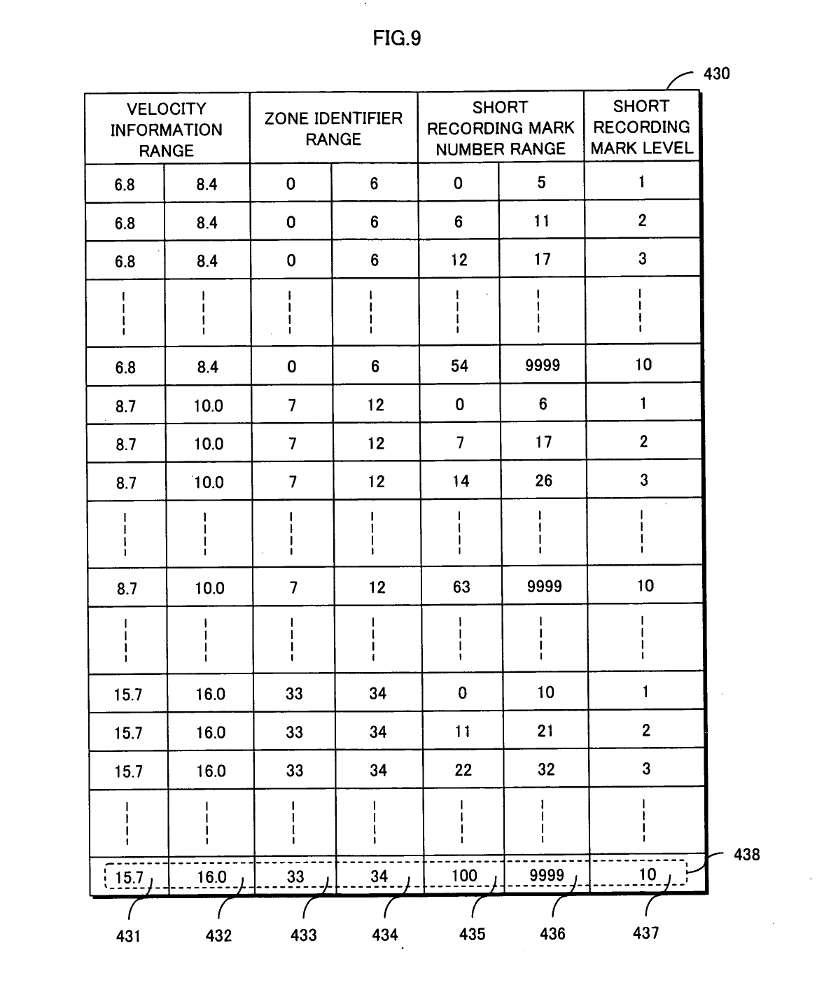

The short recording mark level judging unit 134 holds a level judgment table 430, which is shown in FIG. 9 as an example.

The level judgment table 430 is constituted of a plurality of level judgment entries, each including a velocity information range, a zone information range, a short recording mark number range, and a short recording mark level.

The velocity information range includes start velocity information indicating a start point of the range and end velocity information indicating an end point of the range. The zone identifier range includes a start identifier indicating a start point of the range and an end identifier indicating an end point of the range. The short recording mark number range includes lower limit information indicating a lower limit of the range, and upper limit information indicating an upper limit of the range.

The short recording mark level classifies the short recording mark number into several levels according to the velocity information and the zone identifier range.

The level judging entry 438 includes start velocity information 431 having a value “15.7” and end velocity information 432 having a value “16.0”, which represent that the linear velocity of the disc is in a range of a 15.7× speed to a 16.0× speed inclusive. The level judging entry 438 also includes a zone identifier range including a start identifier 433 having a value “33” and an end identifier 434 having a value “34”, and short recording mark number range including lower limit information 435 having a value “100” and upper limit information 436 having a value “9999” and a short recording mark level 437 having a value “10”.

In the case of receiving parameters, namely the velocity information “16”, the zone identifier “33” and the short recording mark number “110”, the short recording mark level judging unit 134 selects, from the level judgment table 430, a level judgment entry 438 corresponding to the velocity information “16”, the zone identifier “33” and the short recording mark number “110”, and outputs a short recording mark level 437 included in the level judgment entry 438 to the short recording mark adjusting unit 135.

The short recording mark number adjusting unit 135 receives the short recording mark level from the short recording mark level judging unit 134, and converts the number of the detected short recording marks counted by the short recording mark counting unit 116 to a low-speed error number, using the short recording mark number adjustment parameter table.

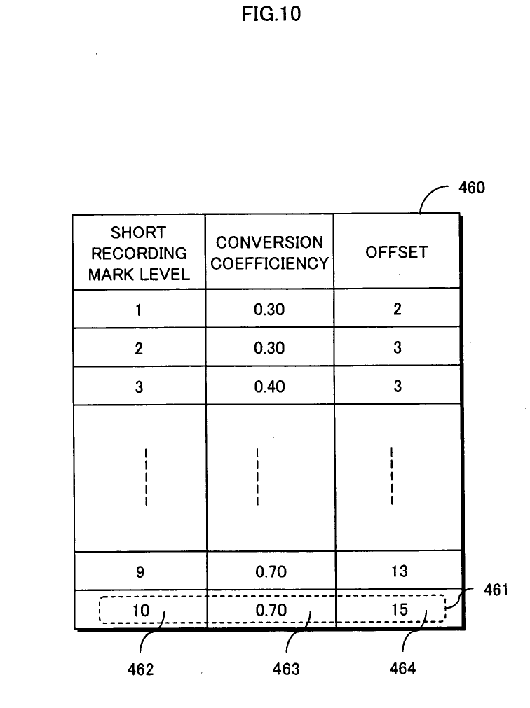

The short recording mark number adjusting unit 135 holds a short recording mark number adjustment parameter table 460, which is shown in FIG. 10 as an example.

The short recording mark number adjustment parameter table is constituted of a plurality of short recording mark number adjustment parameter entries, each including a short recording mark level, a conversion coefficient and an offset.

The short recording mark level represents a level judged by the short recording mark level judging unit 134. The conversion coefficient and the offset are used as parameters for the equation for converting the number of the detected short recording marks to the low-speed error number.

In the third embodiment, the equation is represented by “Low-speed Error Number=Conversion Coefficient×Number of Detected Short Recording Marks+Offset”.

The short recording mark number adjustment parameter entry 461 includes a short recording mark level 462 whose value is “10”, a conversion coefficient 463 whose value is “0.7”, and an offset 464 whose value is “15”.

In the case of receiving a short recording mark level “10” as a parameter, where the number of the detected short recording marks counted by the short recording mark counting unit 116 is “110”, the short recording mark number adjusting unit 135 performs a calculation “0.7×110+15=92”, thereby obtains a low-speed error number “92” as a calculation result.

The level judgment table, the short recording mark number adjustment parameter table, and the conversion equation should be previously determined based on experiments and so on. Alternatively, it is possible to obtain them by simulation and so on, without performing experiments.

The signal quality judging unit 132 receives a linear velocity and a zone identifier from the velocity capability switching unit 136, and selects a zone threshold value corresponding to the received linear velocity and zone identifier.

Next, the signal quality judging unit 132 obtains a low-speed error number from each of the error number converting unit 131 and the short recording mark number adjusting unit 135, and sums up the low-speed error number received from the error number converting unit 131 and the low-speed error number received from the short recording mark number adjusting unit 135. If the sum is not less than the selected zone threshold value, the signal quality judging unit 132 judges that the signal quality is “bad”.

<Operations>

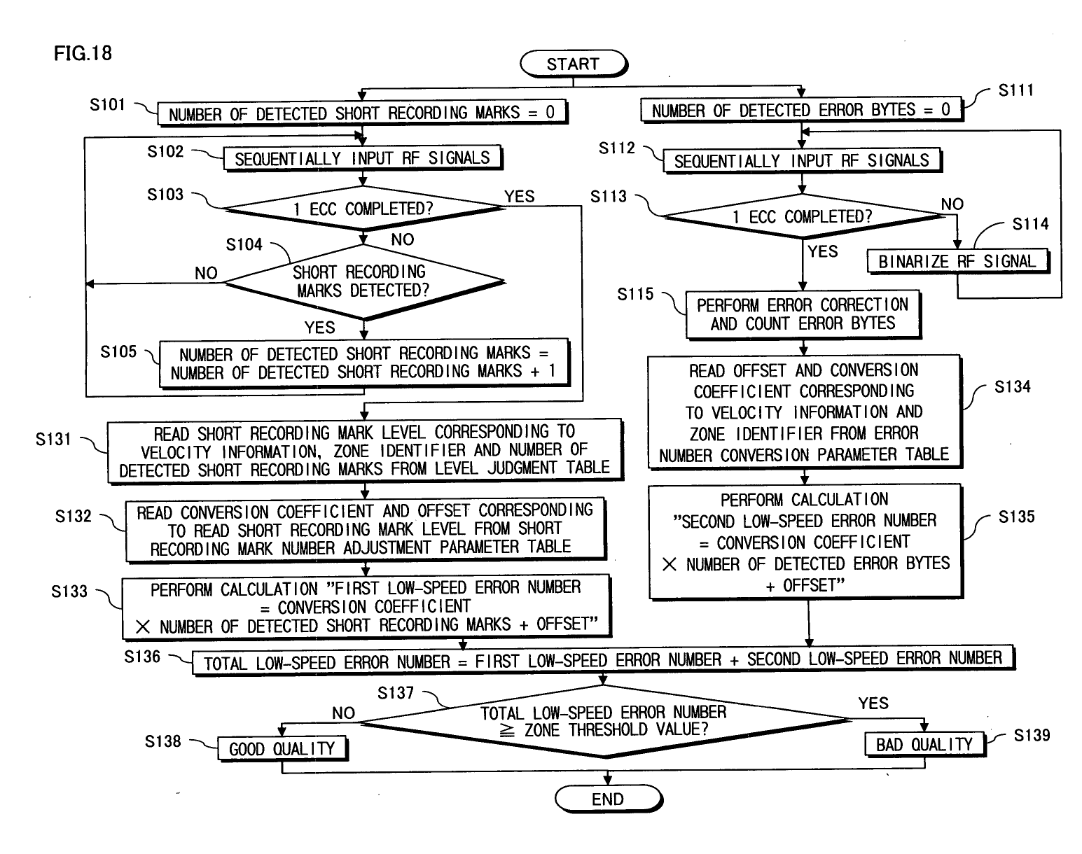

The following describes, with reference to FIG. 18, processing for judging a signal quality relating to one ECC block, which is a main operation of the third embodiment.

In FIG. 18, the same Steps refereed to with the same number as in FIG. 3 perform the same operation. Therefore, they are not described here.

In Step S101 to S105, the short recording mark counting unit 116 counts the number of the detected short recording marks.

The short recording mark level judging unit 134 obtains the number of the detected short recording marks from the short recording mark number counting unit 116, and obtains, from the velocity capability switching unit 136, a velocity information indicating the linear velocity of the optical disc 101 and a zone identifier indicating the zone on the optical disc 101 where is currently used.

The short recording mark level judging unit 134 refers to the level judgment table, reads the velocity information, the zone identifier and the short recording mark level corresponding to the number of the detected short recording marks, and transmits the short recording mark level and the number of the detected short recording marks to the short recording mark number adjusting unit 135 (Step S131).

The short recording mark number adjusting unit 135 receives the short recording mark level and the number of the detected short recording marks, and reads a conversion coefficient and an offset corresponding to the short recording mark level, from the short recording mark adjustment parameter table (Step S132).

The short recording mark number adjusting unit 135 performs a calculation “First Low-speed Error Number=The Read Conversion Coefficient×Number of Detected Short Recording Marks+Offset” to obtain the first low-speed error number (Step S133).

The error number converting unit 131 receives, from the error number counting unit 110, the number of the detected error bytes counted by the error number counting unit 110. The error number converting unit 131 also receives, from the velocity capability switching unit 136, velocity information indicating the linear velocity of the optical disc 101, and a zone identifier indicating the zone on the optical disc 101 where is currently used.

The error number converting unit 131 refers to an error number conversion parameter table to read a conversion coefficient and an offset corresponding to the velocity information and the zone identifier, and calculates “Second Low-speed Error Number=Conversion Coefficient×Number of Detected Error Bytes+Offset” to obtain the second low-speed error number as the result of the calculation. Then the error number converting unit 131 outputs the second low-speed error number to the signal quality judging unit 132 (Step S135).

The signal quality judging unit 132 sums up the first low-speed error number and the second low-speed error number to obtain a total low-speed error number (Step S136).

The signal quality judging unit 132 receives, from the velocity capability switching unit 136, the velocity information indicating the linear velocity of the optical disc 101 and the zone identifier indicating the zone on the optical disc 101 where is currently used. The signal quality judging unit 132 reads the zone threshold value corresponding to the velocity information and zone identifier from the zone threshold value table shown in FIG. 6.

The signal quality judgment unit 132 judges whether the total low-speed error number is not less than the read zone threshold value (Step S137), and if the total low-speed error number is less than the read zone threshold value (Step S137: NO), the signal quality judging unit 132 judges that the signal quality is “good”, and if the total low speed error number is not less than the read zone threshold value (Step S137: YES), the signal quality judging unit 132 judges that the signal quality is “bad” (Step S139).

### Fourth Embodiment

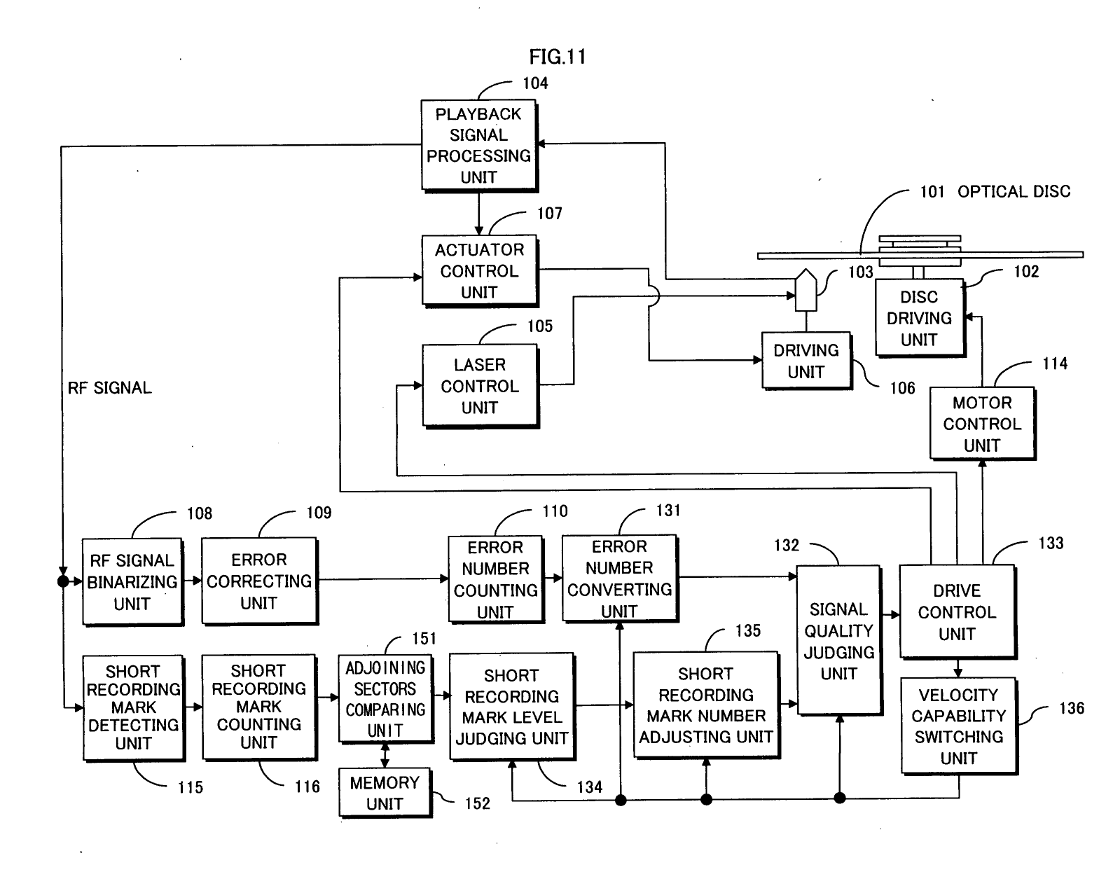

The fourth embodiment is different from the third embodiment in that an adjoining sectors comparing unit 151 and a memory unit 152 are inserted between the short recording mark counting unit 116 and the short recording mark level judging unit 134 as FIG. 11 shows.

In other words, the fourth embodiment is characterized by that the number of the detected short recording marks actually counted by the short recording mark counting unit 116 is adjusted before being used for the judgment of the signal quality.

The following describes operations performed by the adjoining sectors comparing unit 151 and the memory unit 152.

Every time the short recording mark counting unit 116 counts the number of the short recording marks in one sector, the adjoining sectors comparing unit 151 instructs the memory unit 152 to sequentially store the number of the detected short recording marks in each sector.

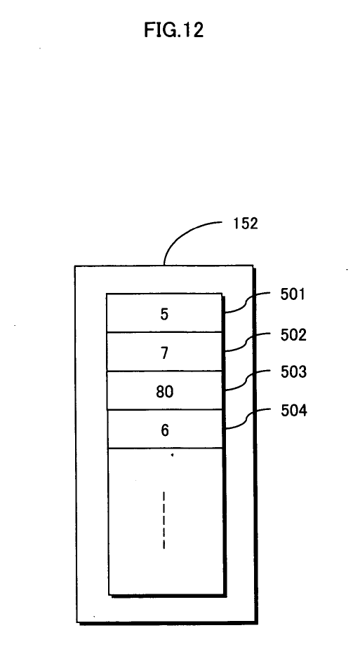

For example, as FIG. 12 shows, the memory unit 152 stores the numbers of short recording marks respectively detected in first to fourth contiguous sectors, namely a number of short recording marks 501 detected in the first sector and having a value “5”, a number of short recording marks 502 detected in the second sector and having a value “7”, a number of short recording marks 503 detected in the third sector and having a value “80” and a number of short recording marks 504 detected in the fourth sector and having a value “6”.

The adjoining sectors comparing unit 151 compares the numbers of the detected short recording marks of three contiguous sectors. If remarkably many short recording marks (e.g. more than ten times) are detected in the middle sector compared to the other two sectors before and after the middle sector, the adjoining sectors comparing unit 151 adjusts the number of the short recording marks detected in the middle sector. For example, a value “60” is set as the upper limit of the number of the short recording marks, and the adjoining sectors comparing unit 151 adjusts the number of the short recording marks based on this upper limit.

For example, the adjoining sectors comparing unit 151 compares the numbers of the detected short recording marks 502 to 504. Then, since the value “80” of the number of the detected short recording marks 503 is greater than ten times of the value “7” of the number of the detected short recording marks 503 and also greater than ten times of the value “6” of the number of the detected short recording marks 504, the adjoining sectors comparing unit 151 replaces the value “80” of the number of the detected short recording marks 503 with the upper limit value “60”.

The adjoining sectors comparing unit 151 subtracts a value “20”, which is the difference between the values “60” and “80”, from the number of the detected short recording marks corresponding to one ECC counted by the short recording mark number counting unit 116. Then, the adjoining sectors comparing unit 151 outputs the subtraction result to the short recording mark level judging unit 134.

In the above described embodiment, the adjoining sectors comparing unit 151 and the memory unit 152 are inserted between the short recording mark number counting unit 116 and the short recording mark level judging unit 134. However, the present invention is not limited to this. For example, the same effect can be achieved if the adjoining sectors comparing unit 151 and the memory unit 152 are inserted between the short recording mark number counting unit 116 and the signal quality judging unit 112 shown in FIG. 1.

<Modifications>

The present invention is described above based on the embodiments. However, the present invention is not limited to the above-described embodiments. The following modifications are included in the present invention as well.

(1) In the first embodiment, the number of the detected error bytes is converted to the corresponding error byte number based on the equation “Error Byte Number=0.4×Number of Detected Short Recording Mark”, for example. However, the present invention is not limited to this.

For example, it is acceptable to use another equation derived from an actual measurement of the corresponding error byte number and the number of the detected short recording marks of a normal optical disc including no write error. Also, it is acceptable to derive an equation from simulation or the like, without performing the actual measurement. Alternatively, instead of using a conversion equation, the error number converting unit 111 may prestore a correspondence table showing a correspondence between the corresponding error byte number and the number of the detected short recording marks, and use the number of the short recording marks corresponding to a received detected error number read from the correspondence table.

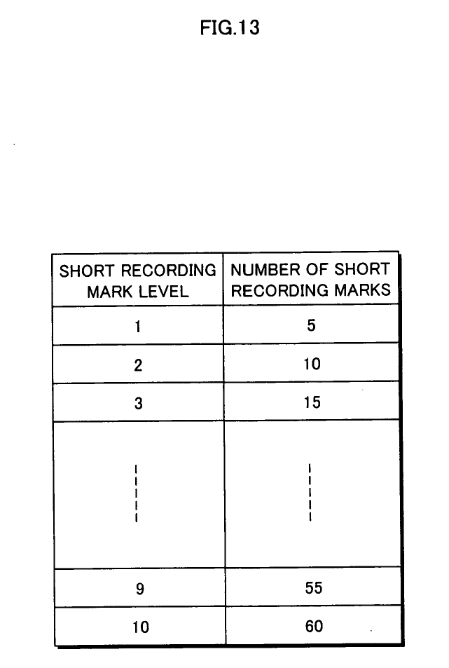

(2) In the third embodiment, the number of the detected short recording marks is converted using the conversion coefficient and the offset for each short recording mark level. However, a correspondence table of FIG. 13, showing a correspondence between the short recording mark level and the number of the short recording marks that is a fixed value, may be prestored and the short recording mark level may be converted to the short recording mark number as a fixed value, with reference to the correspondence table.

Also, it is acceptable to convert the number of the detected short recording marks using the conversion coefficient and the offset, instead of performing the conversion to the short recording mark level.

(3) It is acceptable to switch the above-described signal quality judgment using the number of the detected short recording marks and the number of detected error bytes and the conventional signal quality judgment using only the number of detected error bytes based on the linear velocity of the optical disc.

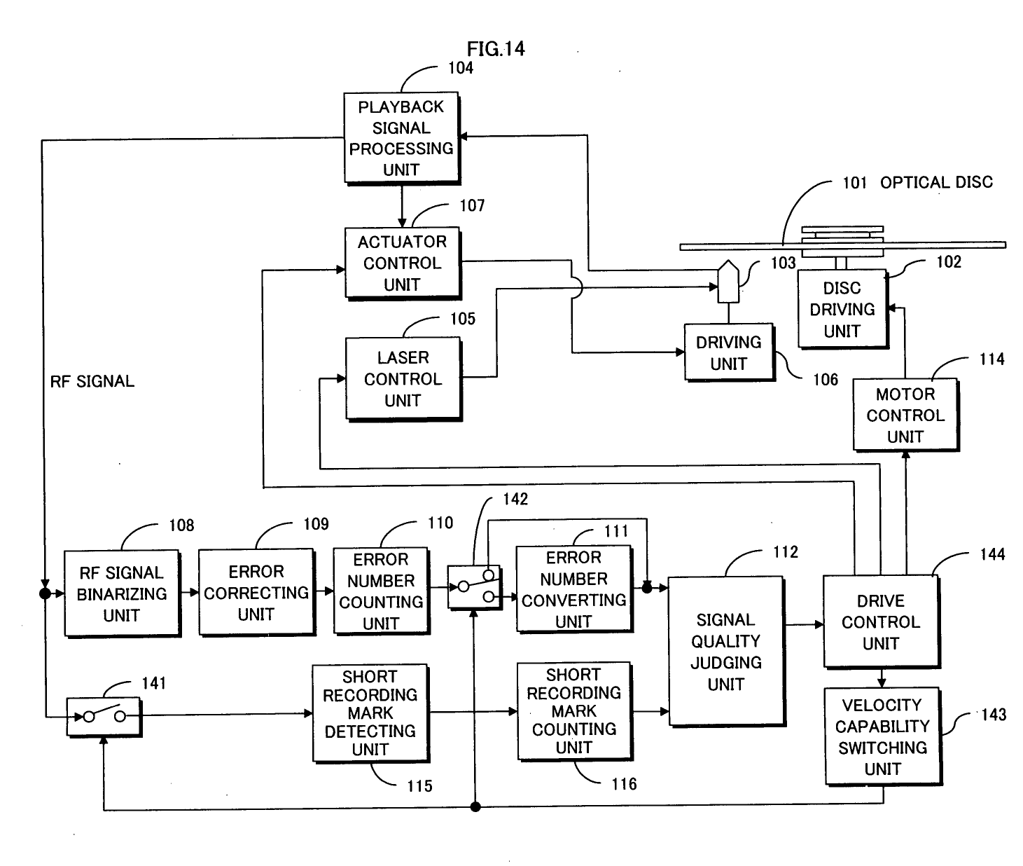

In this modification, as shown in FIG. 14, a switch 141, a selector 142 and a velocity capability switching unit 143 are added to the structure shown in FIG. 1, and the drive control unit 113 is replaced with a drive control unit 144.

The drive control unit 144 is different from the above-described drive control unit 113 in that the drive control unit 144 notifies the velocity capability switching unit 143 of the linear velocity of the optical disc.

The status of the switch 141 is changed between on and off by the velocity changing unit 143. If the switch 141 is on, the playback signal processing unit 104 and the short recording mark detecting unit 115 are connected to each other, and if the switch 141 is off, the playback signal processing unit 104 and the short recording mark detecting unit 115 are disconnected from each other.

The selector 142 selects, in accordance with an instruction from the velocity capability switching unit 143, whether to connect the error number counting unit 110 to the signal quality judging unit 112 or to the error number converting unit 111.

If receiving a linear velocity “16” indicating a 16× speed which is a high speed, the velocity capability switching unit 143 turns on the switch 141, and sets the selector 142 to connect the error number counting unit 110 and the error number converting unit 111.

If receiving a linear velocity “2” indicating a 2× speed, a linear velocity “4” indicating a 4× speed, or a linear velocity “8” indicating a 8× speed from the drive control unit 144, the velocity capability switching unit 143 turns off the switch 141, and sets the selector 142 to connect the error number counting unit 110 and the signal quality judging unit 112.

With the stated structure, if the optical disc is spinning at a high speed, the optical disc apparatus according to this modification performs the above-described signal quality judgment using the number of the detected short recording marks and the number of the detected error bytes, and if the optical disc is spinning at a low speed, the optical disc apparatus performs the conventional signal quality judgment using only the number of the detected error bytes.

(4) It is acceptable to detect the envelope signal of the RF signal output by the playback signal processing unit 104 and if the level of the envelope signal is lower than a predetermined level, not to detect the short recording marks.

This is because if the level of the envelope signal is lower than the predetermined level, the amplitude of the recording signal is low and the RF signal is deteriorated to a large extent, and too many short recording marks might be detected.

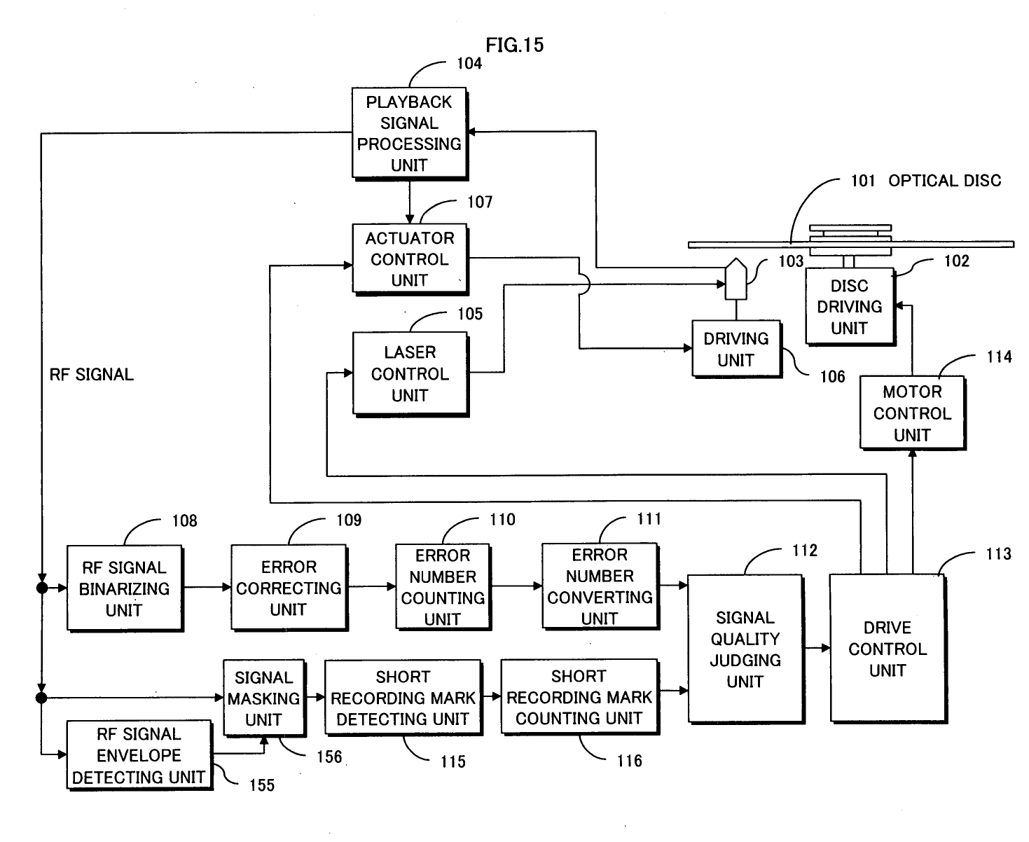

As FIG. 15 shows, an optical disc apparatus according to this modification is structured by adding an RF signal envelope detecting unit 155 and a signal masking unit 156 to the structure shown in FIG. 1.

The RF signal envelope detecting unit 155 receives an RF signal from the playback signal processing unit 104, generate an envelope signal of the received RF signals and judges whether the amplitude of the generated envelope signal is not higher than a predetermined threshold value.

If the amplitude is not higher than the predetermined level, the RF signal envelope detecting unit 155 instructs the signal masking unit 156 to mask the input signal.

The signal masking unit 156 which have received the instruction masks the RF signal received from the playback signal processing unit 104, and outputs the masked signal to the short recording mark detecting unit 115. Since the amplitude of the masked signal is “0”, the short recording mark detecting unit 115 does not detect the short recording marks.

With the stated structure, if the envelope signal of the RF signal is lower than the predetermined threshold value, the signal quality is judged using only the number of the detected error bytes.

(5) FIR (Finite Impulse Response) filter conventionally used for DVD-RAMs regularly calculates filter values and learns the values. However, such filter values are calculated as to arbitrary positions of an arbitrary disc. Therefore, the calculation result varies depending on the position where the value is calculated, and it is difficult to obtain an optimum value for a waveform of a poor signal quality using the filter values obtained by the regular learning. This means that such filter values are too unstable to be standard values.

In this modification, fixed values learned using a standard disc including no write error or ideal values obtained by simulation are used as filter values for the FIR filter to stabilize the RF signal output.

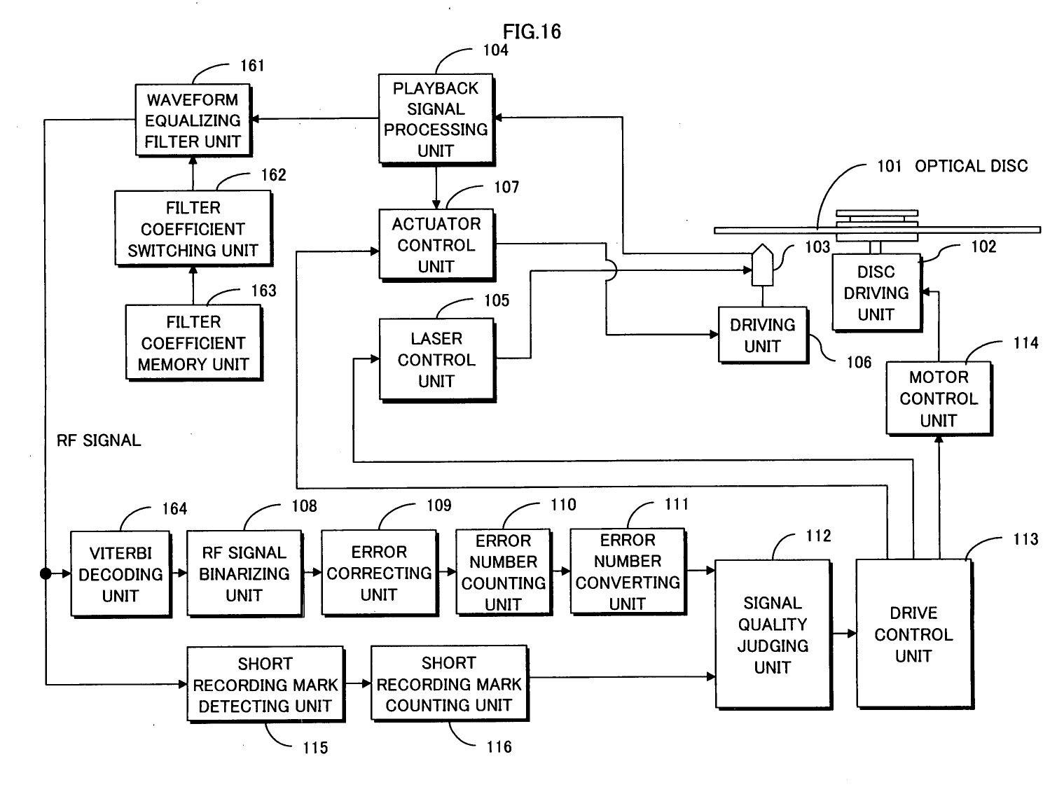

As FIG. 16 shows, an optical disc apparatus according to this modification is structured by adding a wave form equalizing filter unit 161, a filter coefficient switching unit 162, a filter coefficient memory unit 163 and a Viterbi decoding unit 164 to the structure shown in FIG. 1.

The waveform equalizing filter unit 161 is a filter equalizing a waveform of a signal output by the playback signal processing unit 104.

The filter coefficient memory unit prestores a plurality of filter coefficients to be used by the waveform equalizing unit 161.

The filter coefficient switching unit 162 reads the filter coefficient from the filter coefficient memory unit 163 and sets the coefficient to the waveform equalizing filter 161.

The Viterbi decoding unit 164 performs Viterbi decoding on a signal received from the waveform equalizing filter unit 161, and outputs the signal resultant from the Viterbi decoding to the RF signal binarizing unit 108.

The waveform equalizing and the Viterbi decoding are techniques for realizing a high transmission efficient in a system liable to cause transmission path errors. Since they are common techniques, their explanations are omitted here.

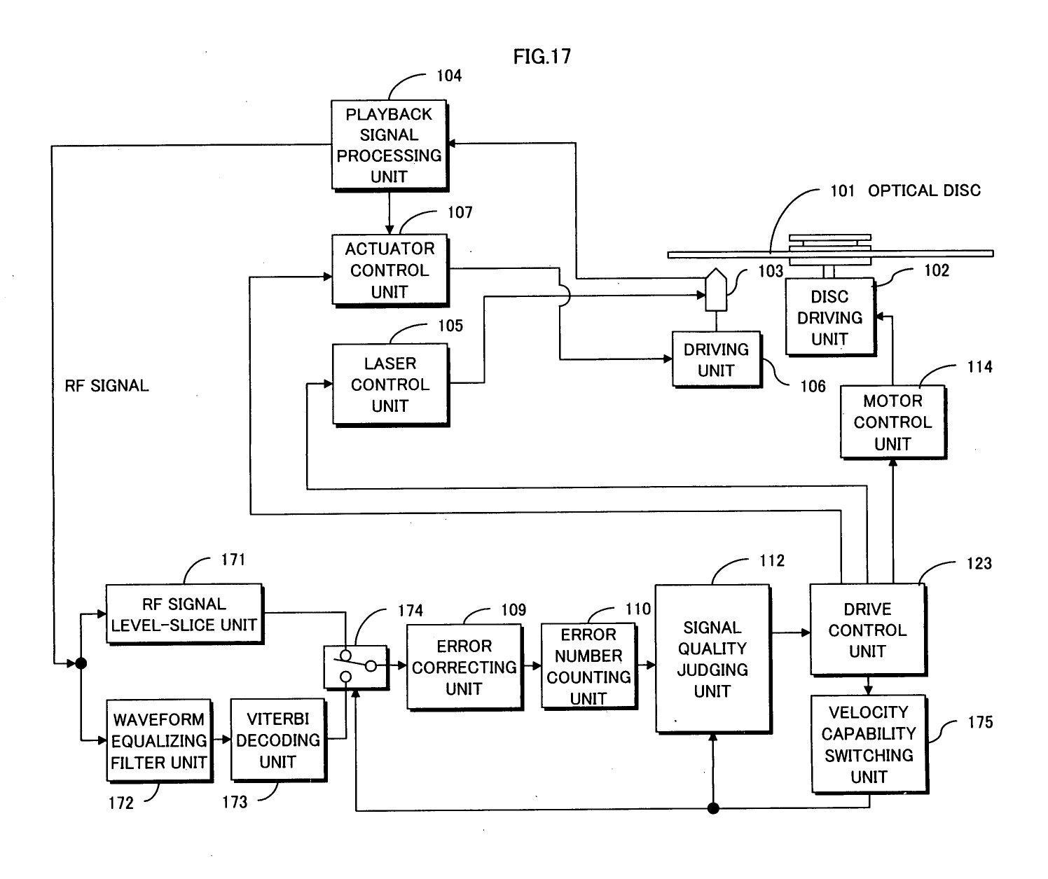

(6) The structure shown in FIG. 17 is acceptable.

An RF signal level-slice unit 171 binarizes an RF signal and outputs the binarized signal.

A waveform equalizing unit 172 performs waveform equalizing on the RF signal received from the playback signal processing unit 104 and outputs the resultant signal.

A Viterbi decoding unit 173 receives, from the waveform equalizing filter unit 172, the signal on which the waveform equalizing is performed, performs Viterbi decoding on the received signal and outputs the resultant signal to the error correcting unit 109.

A selector 174 connects the error correcting unit 109 to either of the RF signal level-slice unit 171 and the Viterbi decoding unit 173 in accordance with an instruction from a velocity capability switching unit 175.

The velocity capability switching unit 175 receives a linear velocity of an optical disc from the drive control unit 123. If the linear velocity is “16” indicating the high speed, the velocity capability switching unit 175 instructs the selector 174 to connect the Viterbi decoding unit 173 to the error correcting unit 109, and if the linear velocity indicates the low speed, the velocity capability switching unit 175 instructs the selector 174 to connect the RF signal level-slice unit 171 to the error correcting unit 109.

With the stated structure, the optical disc apparatus according to this modification performs the waveform equalizing and the Viterbi decoding on the RF signal if the optical disc is spinning at a high speed, and performs the level-slice on the RF signal if the optical disc is spinning at a low speed.

(7) In the above-described embodiments, the parameters such as the conversion coefficient and the offset are changed based on the velocity information. However, the present invention is not limited to this.

For example, the parameters, such as the conversion coefficient and the offset may be changed based only on the zone identifier, without taking the velocity information into consideration.

(8) In the above-described embodiments, in the case where an optical disc is spinning at a high speed, the number of the recording marks recorded as short recording marks are counted. However, the present invention is not limited to this.

For example, in the case where the optical disc is spinning at a high speed, spaces between the recording marks having time lengths of not less than 3T may be read and counted instead of the recording marks, and the signal quality may be judged based on the number of the record spaces that are recognized as short recording spaces whose time lengths are 2T or 1T.

Also, the number of the detected short recording marks and the number of the short recording spaces may be combined and used for judging the signal quality.

(9) In the above-described embodiments, the signal quality is judged within each ECC. However, the present invention is not limited to this. For example, the signal quality may be judged in units of sectors using the number of the detected error bytes and the number of the detected short recording marks, or may be judged in units of ROWs.

(10) Regarding FIG. 5, FIG. 6, FIG. 8, FIG. 9 and FIG. 10, each table includes both the velocity information range and the zone identifier range. However, it is not necessary to include the both. In the case where the velocity information range and the zone identifier range are corresponding to each other one-to-one, the table may include only one of the velocity information range and the zone identifier range for the judgment.

(11) Each of the above-described units is, specifically, a computer system constituted from a microprocessor, ROM, RAM, hard disk unit and the like. A computer program is stored in RAM or on the hard disk unit. Each unit achieves functions as a result of the microprocessor operating in accordance with the computer program. The computer program is a combination of a plurality of instruction codes each giving an instruction to the computer to achieve predetermined functions.

(12) All or a part of the above-described units may be structured by one system LSI (Large Scale Integration) A System LSI is a super-multifunctional LSI, and specifically, structured by a microprocessor, ROM, RAM and the like. The system LSI achieves functions as a result of the microprocessor operating in accordance with the computer program.

(13) All or a part of the above-described units may be structured by a detachable IC card or a module unit. Each of the IC card and the module unit is, specifically, a computer system constituted from a microprocessor, ROM, RAM and the like. The IC card or the module unit may include the above-described super-multifunctional LSI. The IC card or the module unit achieves functions as a result of the microprocessor operating in accordance with a computer program. The IC card or the module unit may be tamper-resistant.

(14) The present invention may be the above-described method. Also, the present invention may be a computer program that realizes the method with a computer, or a digital signal constituting the computer program.

Furthermore, the present invention may be a computer-readable recording medium such as a flexible disk, a hard disk, a CD-ROM, an MO, a DVD-ROM, a DVD RAM, a BD (Blu-Ray Disc) or a semiconductor memory, that stores the computer program or the digital signal. Furthermore, the present invention may be the computer program or the digital signal recorded on any of the aforementioned recording media.

Furthermore, the present invention may be the computer program or the digital signal transmitted on an electric communication line, a wireless or wired communication line, a network of which the Internet is representative, or data broadcasting.

Furthermore, the present invention may be a computer system that includes a microprocessor and a memory, the memory storing the computer program, and the microprocessor operating according to the computer program.

Furthermore, by transferring the program or the digital signal to the recording medium apparatus, or by transferring the program or the digital signal via a network or the like, the program or the digital signal may be executed by another independent computer system.

(15) The present invention may be any combination of the above-described embodiments and modifications.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. A signal processing device for recording and playing back data on an optical disc on which one or more recording tracks are concentrically or spirally formed, the signal processing device comprising:
a short recording mark detecting unit operable to detect short recording marks from an RF signal generated based on light reflected from the optical disc, the short recording marks being shorter than a shortest recording mark defined in a standard;
a short recording mark counting unit operable to count a first short recording mark number that is the number of the short recording marks detected by the short recording mark detecting unit;
an RF signal binarizing unit operable to binarize the RF signal;
an error correcting unit operable to correct errors in the binarized RF signal;
an error counting unit operable to count the number of the errors;
an error number converting unit operable to convert the number of the errors to a second short recording mark number that is the number of short recording marks indicating the same signal quality as the number of the errors indicates; and
a signal quality judging unit operable to judge recording quality based on a total of the first short recording mark number and the second short recording mark number.

2. The signal processing device of claim 1 further comprising
a velocity capability switching unit operable to switch, in accordance with a linear velocity of the optical disc and an instruction from a drive control unit, a conversion coefficient or an offset value used by the error number converting unit and a judgment level used by the signal quality judging unit.

3. The signal processing device of claim 1 further comprising
a short recording mark number adjusting unit operable to adjust the first short recording mark number by multiplying by an adjustment coefficient or adding an offset value, to obtain a first adjusted error number, wherein
the error number converting unit converts the number of the errors counted by the error number counting unit to a second adjusted error number, and
the signal quality judging unit judges the recording quality based on a total of the first adjusted error number and the second adjusted error number.

4. The signal processing device of claim 3 further comprising
a velocity capability switching unit operable to switch, in accordance with a linear velocity of the optical disc and an instruction from a drive control unit, a conversion coefficient or an offset value for the error number converting unit, a adjustment coefficient or an offset value for the short recording mark number adjusting unit, and a judgment level for the signal quality judging unit.

5. The signal processing device of claim 3 further comprising
a short recording mark level judging unit operable to judge a level of the first short recording mark number, wherein
the short recording mark number adjusting unit adjusts the first short recording mark number by changing the adjustment coefficient or the offset value in accordance with the level judged by the short recording mark level judging unit.

6. The signal processing device of claim 5 further comprising
a velocity capability switching unit operable to switch, in accordance with a linear velocity of the optical disc, a conversion coefficient or an offset value used by the error number converting unit, the level judged by the short recording mark level judging unit, the adjustment coefficient or the offset value used the short recording mark number adjusting unit, and the judgment level used by the signal quality judging unit.

7. The signal processing device of claim 5 further comprising, instead of the short recording mark number adjusting unit,
a short recording mark replacing unit operable to replace the first short recording mark number with a fixed value in accordance with the level judged by the short recording mark level judging unit.

8. The signal processing device of claim 7 further comprising
a velocity capability switching unit operable to switch, in accordance with a linear velocity of the optical disc and an instruction from a drive control unit, a conversion coefficient or an offset value used by the error number converting unit, the judgment level used by the short recording mark level judging unit, the fixed value used by the short recording mark number adjusting unit, and the judgment level used by the signal quality judging unit.

9. The signal processing device of claim 1 further comprising:
a memory unit operable to store the first short recording mark number in each of adjoining sectors; and
an adjoining sectors comparing unit operable to compare the first short recording mark number of a certain sector among the adjoining sectors and the first short recording mark number of sectors adjoining the certain sector, and judge whether each first short recording mark number is more than a predetermined value, wherein
the short recording mark number adjusting unit adjusts the first short recording mark number of each of the adjoining sectors to obtain an adjusted short recording mark number in accordance with a result of the judgment by the adjoining sectors comparing unit.

10. The signal processing device of claim 1 further comprising
a velocity capability switching unit operable to switch units to be used for judging the recording quality in accordance with a linear velocity of the optical disc such that an RF signal level-slice unit, the error correcting unit and the error counting unit are used if the linear velocity is low, and the short recording mark detecting unit, the short recording mark counting unit, the RF signal binarizing unit, the error correcting unit, the error counting unit, the error number converting unit and the signal quality judging unit are used if the linear velocity is high.

11. The signal processing device of claim 1 further comprising:
an RF signal envelope detecting unit operable to detect existence of the RF signal; and
a signal masking unit operable, if the RF signal is missing, to mask a signal input to the short recording mark detecting unit so as not to detect the short recording marks.

12. The signal processing device of claim 1 further comprising:
a waveform equalizing filter unit and a Viterbi decoding unit operable to perform PRML processing;
a filter coefficient memory unit that prestores a filter coefficient for testing the recording quality; and
a filter coefficient switching unit operable to set the filter coefficient to the waveform equalizing filter unit when testing or verifying the quality of the RF signal.

13. A signal processing device for recording and playing back data on an optical disc on which one or more recording tracks are concentrically or spirally formed, the signal processing device comprising:
an RF signal binarizing unit operable to binarize an RF signal generated based on light reflected from the optical disc;
an error correcting unit operable to correct errors in the binarized RF signal;
an error counting unit operable to count the number of errors that the error correcting unit has failed to correct;
an error number converting unit operable to convert the number of the errors to a second short recording mark number that is the number of short recording marks indicating the same signal quality as the number of the errors indicates;
a waveform equalizing filter unit and Viterbi decoding unit operable to perform PLML processing on an output from a playback signal processing unit;
a signal quality judging unit operable to judge recording quality based on an output from the error number counting unit or an output from the Viterbi decoding unit; and
a velocity capability switching unit operable, in accordance with a linear velocity of the optical disc, to switch an input to the signal quality judging unit to an output from the error number counting unit if the linear velocity is low, and to an output from the Viterbi decoding unit if the linear velocity is high.

14. The signal processing device of claim 13, wherein
the velocity capability switching unit switches a judgment level used by the signal quality judging unit in accordance with the linear velocity of the optical disc.
